(19) United States
(12) Patent Application Publication
(10) Pub. No.: US 2020/0374992 A1
(43) Pub. Date: Nov. 26, 2020

(54) 433 MHz Solid State Microwave Heating Cavity and Industrial Defrosting System

(71) Applicant: Ocean University of China, Qingdao City (CN)

(72) Inventors: Changhu XUE, Qingdao (CN); Qianqian XUE, Qingdao (CN); Yunqi WEN, Qingdao (CN); Rui JIANG, Qingdao (CN); Ruxue JIANG, Qingdao (CN); Huanhuan CUI, Qingdao (CN); Bingxue JIANG, Qingdao (CN); Xiaohan WANG, Qingdao (CN); Xiao KE, Qingdao (CN); Xin DU, Qingdao (CN); Xiaoming JIANG, Qingdao (CN)

(21) Appl. No.: 16/878,654

(22) Filed: May 20, 2020

(30) Foreign Application Priority Data
May 21, 2019 (CN) 201910421390.2

(51) Int. Cl. H05B 6/64; H05B 6/68

(52) U.S. Cl. CPC H05B 6/6402; H05B 6/6455; H05B 6/688

(57) ABSTRACT

The disclosure relates to 433 MHz solid state microwave heating cavity and industrial defrosting system. The 433 MHz solid state microwave heating cavity and industrial defrosting system includes a sample conveying device, a metal detector, a microwave processing system, and a motor, provided on a machine frame. An upper part and a bottom part of a microwave processing module are provided with a microwave source separately. Microwave sources are connected to bell mouths through wave guide tubes. Two bell mouths are connected to a heating cavity through microwave windows. The microwave source is a 433 MHz solid-state microwave source. The high-power-density 433 MHz microwave is used to penetrate meat products to make a uniform temperature inside and outside after defrosting, the defrosting takes only 2-4 minutes from −18° C. to −2° C., color and nutrients of the meat products after the defrosting are basically the same as those of fresh meat.

### CROSS-REFERENCE TO RELATED APPLICATION(S)

The present application claims priority to Chinese Patent Application No. 201910421390.2, filed on May 21, 2019 and entitled “433 MHz solid state microwave heating cavity and industrial defrosting system 433 MHz”, the contents of which are hereby incorporated by reference in its entirety.

### TECHNICAL FIELD

The disclosure relates to a microwave defrosting device, and more particularly, to 433 MHz solid state microwave heating cavity and industrial defrosting system.

### BACKGROUND

Microwave defrosting is to quickly raise the temperature of a frozen product from −42° C. to −18° C. to a non-drip state of −2° C. using the penetration and selective heating characteristics of microwaves. Microwave defrosting is to place food product within alternative electromagnetic waves environment. Heat generates within food due to molecule friction while polar molecules vibrates with high-frequency microwave radiation. The heating mode is generated at the whole volume of a product material. Microwave defrosting has the advantages of low production cost, high efficiency, no bacteria growth of products and small footprint, which are unmatched by other defrosting modes.

Cryopreservation of meat is a better method to maintain stable meat quality, but when defrosting frozen meat, different defrosting methods have a great influence on the quality of the defrosted meat. Traditional defrosting methods include air defrosting and water defrosting. During the defrosting process, heat is transferred from the surface of a meat block to the inside by means of a conduction heat transfer manner. This method not only has a long defrosting time, but also has a high rate of juice loss during the defrosting process and makes the meat easily contaminated by microorganisms, so that the quality of the defrosted meat is lowered. Therefore, microwave volumetric defrosting mode is considered to defrost meat. However, most of the major domestic defrosting equipment is 915 MHz and 2450 MHz, which have low efficiency and, low penetration depth of meat packs, and need to be equipped with steam heating and defrosting functions before and after defrosting. The process is complicated and the operation is inconvenient.

At present, how to achieve fast and uniform defrosting for large size, irregular shape of different varieties of food using microwave high-power, o is a technical problem. The existing 915 MHz and 2450 MHz microwave defrosting equipment has low penetration depth, poor uniformity and repeatability, the suitable cavitysize for 915 MHz and 2450 MHz is small, and it is impossible to achieve industrial amplification simply by proportional enlargement. The design of the 433 MHz cavity is of an industrial level, and it can meet the requirements of industrial production.

### SUMMARY

The technical problem solved by some embodiments of the disclosure is the uniformity of defrosting under high-power microwave and the adaptability to samples of different properties. The uniformity of the existing equipment has great problems, the uniformity can meet the requirements at low power, but when the microwave power is increased during industrial amplification, the rate of microwave absorption by heated food is proportional to the square of electric field intensity. The power increase may rapidly amplify the heating non-uniformity, lead to a huge temperature difference between the hot and cold points, and lead to the deterioration of the quality of defrosted products. Much patented equipment can only realize microwave defrosting. There is no theoretical cavity design for heating uniformity, electric field distribution thus the problem of non-uniform defrosting is still not be fundamentally solved.

For example, the patent 201810594541 “High-Power Industrial Microwave Defrosting Equipment” has the following defects:

(1) The equipment uses mode stirrer, which is the same as a flat domestic microwave oven in a kitchen, which can increase the turbulence of varying electric field distribution in order to improve the heating uniformity,. But the heating uniformity and edge overheating effects cannot be fundamentally solved.

(2) It is impossible to adjust the design of the heating cavity according to different samples to be defrosted. The wave conversion technology is to increase the degree of turbulence in the electric field. The distribution of the electric field is unstable and the repeatability is poor. It is impossible to perform targeted design on products to be defrosted of different types, shapes and sizes.

The patent 201811443594 “Pork Microwave Defrosting Device and Method” has the following defects: the design of this patent can only be used to defrost pork, and it cannot be targeted for products to be defrosted of different types, shapes and sizes. The pork size used by an instrument is 5*5*10 cm (212.5 g), and the size is too small to be suitable for industrial defrosting.

In order to solve the above problem, the disclosure provides 433 MHz solid state microwave heating cavity and industrial defrosting system, high-power-density 433 MHz microwave is used to penetrate meat products to make a basic uniform temperature inside and outside after defrosting, the defrosting process takes only 2-4 minutes from −18° C. to −2° C., color and nutrients of the meat products after the defrosting are almost the same as those of fresh meat, continuous production minimizes proliferation of harmful micro-organisms, and the equipment is a current advanced defrosting mode of the meat products.

In order to achieve the above purpose, the disclosure is implemented using the following technical solution: 433 MHz solid state microwave heating cavity and industrial defrosting system, including: a sample conveying device, a metal detector, a microwave processing system, a motor, and a reflecting surface adjusting device, provided on a machine frame.

The motor is connected to the sample conveying device through a cable and supplies power thereto. The sample conveying device is a non-metallic conveying device, passes through the microwave processing system, and runs from the metal detector to a direction of a rear end.

The metal detector is provided on one side of a feeding end of a conveyor belt, and metal-containing materials are screened out at a feeding inlet to avoid metal substances from entering the microwave processing system. If there is a small volume of metal, microwaves will enter from the surrounding of the metal. The temperature of the surrounding area of the metal is too high, the temperature difference is large, and the quality is degraded. The larger metal will cause microwave shielding and cannot implement defrosting. The microwave processing system is arranged behind the metal detector, and includes two or more microwave processing modules connected in sequence, which may be optimally combined according to different requirements to obtain better heating uniformity.

An upper part and a bottom part of the microwave processing module are provided with a microwave source separately. The microwave sources are connected to bell mouths through wave guide tubes. The bell mouths are configured to evenly disperse the microwaves. It can be designed in advance according to different types and sizes of defrosted products, and the components can be replaced later as needed to ensure the uniformity of heating. The upper mouth and the lower bell mouth are connected to a heating cavity through a microwave window. The microwave enters the heating cavity through the microwave window. The microwave window also prevents water vapor and dust from entering the instrument. The microwave enters a heating cavity composed of six walls, only one solution of a simple four-dimensional equation system is single-mode, and multiple solutions are multi-mode. The single mode design of the disclosure is that a standing wave mode is a standing wave, there are stable cold points and hot points, the stability of an electric field is good, and the temperature distribution is stable.

The traditional multi-mode design of the microwave defrosting system has numerous hot points and cold points, so it is impossible to determine where are the actual hot points and cold points. Taking Nanjing Sanle as an example, the reason for adopting the mode stirrer is that the multi-mode model is adopted, the electric field has been in a disordered state, and the stability of the electric field is poor. The uniformity can be improved by increasing the disorder degree of electric field, but which disorder degree can be achieved, and what means can be used to increase to enough disorder degree? The positions of the hot point and cold point of the sample can not be determined completely when it is defrosted by the microwave defrosting system; the uniformity of heating can be improved by rotating, and the increased degree of the uniformity of heating can not be determined, there is no relevant research at present. When the power is amplified, the positions of the hot point and cold point cannot be determined. At this time, this place is hot. Next time, another place is hot. The positions of the hot point and cold point are uncertain and the repeatability is poor. In the case of the multi-mode, it is difficult to determine the the hot point and cold point when changing the type of the sample.

In addition to the single-mode model, the microwave source is a 433 MHz solid-state microwave source. For samples to be defrosted of the same volume, shape and size, the 433 MHz wavelength is longer, the penetration depth is large, the penetration effect is good, the 433 MHz standing wave is less, and the distance between cold points and hot points is large. The uniformity problem can be solved by heat type complementation. pointpointpointpointCompared to 915 MHz and 2450 MHz, there are dozens of cold points and hot points, so the edge heating effect point is more stronger, 433 MHz may only have one or two cold points and hot points, which is more conducive to the use of heat type distribution for electric field complementary design. Moreover, because a 433 MHz magnetron needs to form a microwave with a wavelength as long as 669 mm-717 mm, the magnetron also needs an oscillation cavity. The oscillation cavity requires a very large volume to generate such a long microwave, so the size the heating cavities an originally industrial level size, and there is no need of industrial amplification to meet the requirements of industrial production. On the other hand, the use of a solid-state source can greatly reduce the volume of the magnetron and a power supply. At the same time, it has the characteristics of high controllability, small size, and high frequency stability, and the frequency, power (forward/reverse), phase, etc. during the operation of the equipment can be fed back and adjusted in real time to improve heating uniformity. A side surface of the heating cavity is provided with the reflecting surface adjusting device, including a metal inner plate, a screw rod and a scissor adjusting mechanism, both ends of the scissor adjusting mechanism are fixedly connected to the inner plate and a metal plate on the side surface of the heating cavity, respectively, the screw rod passes through the metal plate, and an end is a handle. The handle is rotated to adjust the length of the screw rod in the heating cavity, thereby adjusting the position of the inner plate and adjusting the width of the heating cavity, so as to adjust the electric field distribution according to the actual situation to ensure the uniformity of heating. The 433 MHz wavelength is very long, the screw rod and a hole are in screw thread contact and no gap, which can prevent the microwave from leaking out.

In an exemplary embodiment, the sample conveying device includes gears provided on both sides of the machine frame, and a chain conveyor belt mounted on the gears, the chain conveyor belt is made of a non-metallic material, and a bottom part of the chain conveyor belt is provided with a support member made of a non-metallic material.

In an exemplary embodiment, a discharging end of the sample conveying device is provided with an infrared temperature measuring instrument, capable of measuring the surface temperature of a sample in real time, and monitoring a defrosting situation.

In an exemplary embodiment, the machine frame is further provided with a control system, including a PLC and a touch screen connected to the PLC, and the PLC controls the sample conveying device, the metal detector, the microwave processing system, the infrared temperature measuring instrument, and the motor through the cable. The touch screen is used to operate the control system, set the operation, alarm, prompt and other instructions, establish a defrosting material process package database, perform related processes according to different materials, and set a function of automatic defrosting with materials and automatic standby without materials.

In an exemplary embodiment, the microwave window is a flat plate shape or a solid cylindrical shape. The flat plate shape is a commonly used microwave window, which is convenient to manufacture, and the solid cylindrical type can better focus the microwave. It can be replaced as needed before installation or after the equipment is disassembled to ensure the uniformity of heating.

In an exemplary embodiment, the height of the heating cavity is 30-60 cm and the width is 30-60 cm, which is suitable for the defrosting of various meat standard packages (30 cm*60 cm*20 cm) and different shapes and sizes of meat and seafood.

In an exemplary embodiment, the front end and the rear end of the microwave processing system are open for the sample conveying device to pass through, both the feeding end and the discharging end of the sample conveying device are provided with a microwave suppressor, the microwave suppressor includes a reflecting part and an absorbing part, the reflecting part is usually metal of an irregular shape, and the absorbing part is usually a graphene or silicon carbide plate, which is used to absorb the reflected microwave. The microwave suppressor currently on the market can be realized. For the specific structure, reference may be made to patent 201310631185.1 “Microwave Suppressor and Tunnel Microwave Heating System” and 2018212792024 “Archipelago Microwave Suppressor”. The test results show that the microwave leakage during the microwave operation of the disclosure is generally 1-2.5 mW/cm².

In an exemplary embodiment, the microwave power of the microwave processing module is greater than or equal to 20 KW.

In an exemplary embodiment, the wave guide tube selects the national standard BJ4, and has a width of 533.4 mm and a height of 266.7 mm.

In an exemplary embodiment, the 433 MHz solid-state microwave source is electrically connected to the PLC, and a working state of the 433 MHz solid-state microwave source is adjusted through the touch screen. The 433 MHz solid-state microwave source is capable of calculating the intensity of a reflected wave and acquiring corresponding dielectric characteristic parameter information according to the intensity of the reflected wave. The 433 MHz solid-state microwave source acquires dielectric characteristic parameter information in real time, and determines a defrosting state of current food according to the change of the dielectric characteristic parameter information.

In an exemplary embodiment, the touch screen is capable of displaying the following information: species of food, intensity of the reflected wave, reflected power, real-time dielectric characteristic parameter information, and the defrosting state.

In an exemplary embodiment, the PLC adjusts the heating power of the 433 MHz solid-state microwave source corresponding to the next microwave processing module according to the defrosting state of the current food, so as to achieve heat type complementation of each microwave processing module.

In an exemplary embodiment, there are two or more heating cavities, the PLC adjusts the heating power of the 433 MHz solid-state microwave source corresponding to the next microwave processing module according to the defrosting state of the current food, so as to realize the complementary heat type of each microwave processing module and achieve the purpose of defrosting different foods uniformly.

In an exemplary embodiment, there are multiple reflecting surface adjusting devices, each of the heating cavities is provided with two reflecting surface adjusting devices, the two reflecting surface adjusting devices in the same heating cavity are respectively provided on both sides of the sample conveying device, the space between the two inner plates of the two reflecting surface adjusting devices is the space through which food passes, and a distance between the two inner plates is adjusted to adjust an electric field distribution, and each of the inner plates is adjustable independently.

The device is applied to the defrosting of various meat standard packages (30 cm*60 cm*20 cm) and meat and seafood of different shapes and sizes. The material can be returned to the temperature range of −4 to −2° C. Meat standard packages (30*60*20 cm, with plastic packaging films) are included: duck meat, beef quarters, beef tenths, pork sixths, lamb, etc.; irregular shapes and sizes of food: lamb legs, whole chickens, ducks, livestock, poultry, etc.; aquatic products: fish slip, shrimp slip, surimi, frozen shrimp, etc. According to different objects, different sizes of the bell mouth, the size and type of the microwave window and the width of the heating cavity can be designed. When changing the defrosted object, only the corresponding size parts need to be replaced according to the object. The entire production cable does not need large-scale reconstruction, which greatly improves the flexibility of use and saves a lot of costs.

The defrosting process is as follows: a material is placed on a food carrier, a meat standard block or a sample to be defrosted is placed on a feeding end of a conveyor belt, after a metal detector passes the test, the conveyor belt runs automatically, a target defrosting temperature is reached by microwave processing of a microwave heating cavity, after an infrared temperature measuring instrument measures the temperature, the material is discharged from a discharging end, and quick non-destructive defrosting is realized.

The beneficial effects of the disclosure are as follows.

(1) A vertically symmetrical structure of horn-shape cavity is adopted, a single-mode design (single-mode design refers to only one standing wave mode with good electric field stability and stable temperature distribution) is adopted, a microwave field is stable, the defrosting uniformity and the repeatability are good, the modular design of the heating cavity is adopted, and the electric field distribution is complementary. Compared with a single heating cavity, the uniformity is better, the repeatability is better, and the phenomenon of external heat and internal cooling does not occur.

(2) The width of the heating cavity and a series of changes can be made for different samples to obtain an optimal uniformity treatment scheme for the material.

(3) Different meats have different dielectric properties (dielectric constant, dielectric loss and penetration depth), different shapes and different sizes due to differences in water content and other components. The heat type and energy distribution during the microwave defrosting of different meats are different. The disclosure can achieve the purpose of uniformly defrosting different kinds of food by adjusting the size of the bell mouth, the width of the heating cavity, the size and shape of the microwave window, and the combination of the microwave heating cavity module.

For example, a meat standard package and a frozen shrimp standard package (30 cm*60 cm*20 cm) of the same size are taken as an example, the existing heating cavity size is suitable for defrosting the frozen shrimp standard package, but for the presence of lamb, the energy distribution is uneven, the temperature difference of cold and hot points is large, and the penetration depth is insufficient.

(4) The existing equipment can only adjust the process parameters, and cannot adjust the heating cavity according to different materials. The disclosure uses a heating cavity modular design and multiple heating cavity electric field distribution complementary design, the control system may automatically adjust the power of the heating cavity to be passed, the adjusting power can be automatically matched, energy is saved, and the defrosting temperature of the same batch is more uniform. Meanwhile, a lifting device is designed to change the width of the heating cavity to adjust the energy distribution. The metal plates on both sides of the microwave heating cavity are reflecting surface adjusting devices. The function of adjusting the electric field distribution is achieved by adjusting the distances of the metal plates and the cavity wall of the microwave heating cavity, and the purpose of defrosting different materials evenly is achieved.

(5) The equipment can heat 25 kg of meat from −25° C. to −2° C. within only 2-4 minutes. The penetration depth of a 433 MHz microwave is twice that of a 915 MHz microwave and 6 times that of a 2450 MHz microwave, energy is saved, and the environment is protected. The entire defrosting process does not require large sites and large amounts of water, and is pollution-free, energy-saving and environmentally friendly. Microwave defrosting avoids blood flow and pollution and maintains the original color, the meat loss rate is less than 1%, the meat standard package defrosting is more uniform, there is no change in protein, color and other qualities, there is no damage to nutrients and there is little loss of materials.

(6) The disclosure uses microwave suppressors, the two sides are connected, the production process is unimpeded, continuous production can be achieved, the safety protection function is perfect, and no microwave leakage will occur.

(7) The 433 MHz solid-state source covers a small area, requires little investment, and can save costs.

(8) Microwave defrosting is carried out in a stainless steel closed cavity. The box and conveyor belt can be safely rinsed without water defrosting, there is no pollution, and the growth of bacteria is avoided.

(9) In addition to detecting temperature changes with the infrared temperature measuring instrument, the equipment can analyze changes in the dielectric properties of defrosted foods by calculating the intensity of reflected waves (reflected power). Due to the phase change before and after defrosting, the dielectric properties of food are changed significantly, and when the dielectric characteristic value reaches a certain range, the corresponding defrosting situation is determined.

### BRIEF DESCRIPTION OF THE DRAWINGS

In order to more clearly illustrate the embodiments of the disclosure or the technical solutions in the conventional art, the drawings used in the description of the embodiments or the conventional art will be briefly described below. It is apparent that the drawings in the following description are only some embodiments of the disclosure, and other drawings can be obtained from those skilled in the art according to these drawings without any creative work.

FIG. 1 is a schematic structure diagram of the disclosure.

FIG. 2 is a top view of the disclosure.

FIG. 3 is a schematic structure diagram of a microwave processing module.

FIG. 4 is a schematic structure diagram of a flat-plate microwave window.

FIG. 5 is a schematic structure diagram of a solid-cylindrical microwave window.

FIG. 6 is a schematic cross-sectional structure diagram of a reflecting surface adjusting device.

FIG. 7A-FIG. 7C is an electric field distribution diagram.

FIG. 8 is a schematic diagram of electric field complementation (a shaded part is a cold point, the other part is a hot point, and as the shadow density is larger, the temperature is lower).

In the drawings, 1: machine frame, 2: sample conveying device, 21: gear, 22: chain conveyor belt, 3: metal detector, 4: microwave processing module, 41: microwave source, 42: wave guide tube, 43: bell mouth, 44: microwave window, 45: heating cavity, 451: inner plate, 452: screw rod, 453: scissor adjusting mechanism, 454: handle, 46: metal plate, 5: motor, 6: control system, 7: infrared temperature measuring instrument, a: heating cavity, b: heating cavity, c: heat type passing through heating cavity a and heating cavity b, 8: front-end channel cover, 9: middle connecting cover, 10: rear-end channel cover.

### DETAILED DESCRIPTION OF THE EMBODIMENTS

In order to make the objectives, technical solutions and advantages of the embodiments of the disclosure clearer, the technical solutions in the embodiments of the disclosure will be clearly and completely described hereinbelow with the drawings in the embodiments of the disclosure. It is apparent that the described embodiments are part of the embodiments of the disclosure, not all of the embodiments. On the basis of the embodiments of the disclosure, all other embodiments obtained on the premise of no creative work of those of ordinary skill in the art fall within the scope of protection of the disclosure.

### Embodiment 1

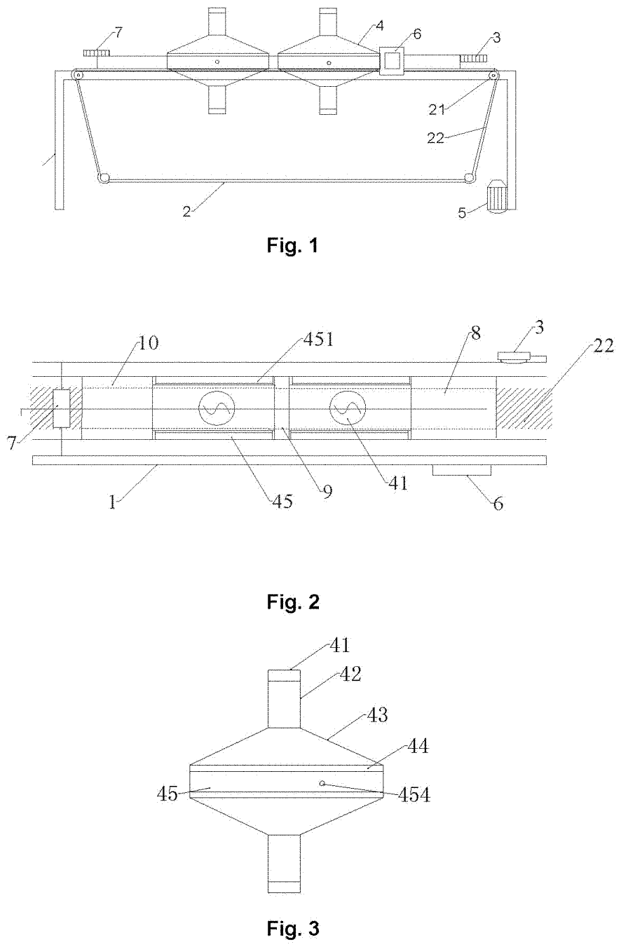

As shown in FIG. 1 and FIG. 2, 433 MHz solid state microwave heating cavity and industrial defrosting system includes a sample conveying device 2, a metal detector 3, a microwave processing system, and a motor 5, provided on a machine frame 1.

The motor 5 is connected to the sample conveying device 2 through a cable and supplies power thereto. The sample conveying device 2 is a non-metallic conveying device, passes through the microwave processing system, and runs from the metal detector 3 to a direction of a rear end.

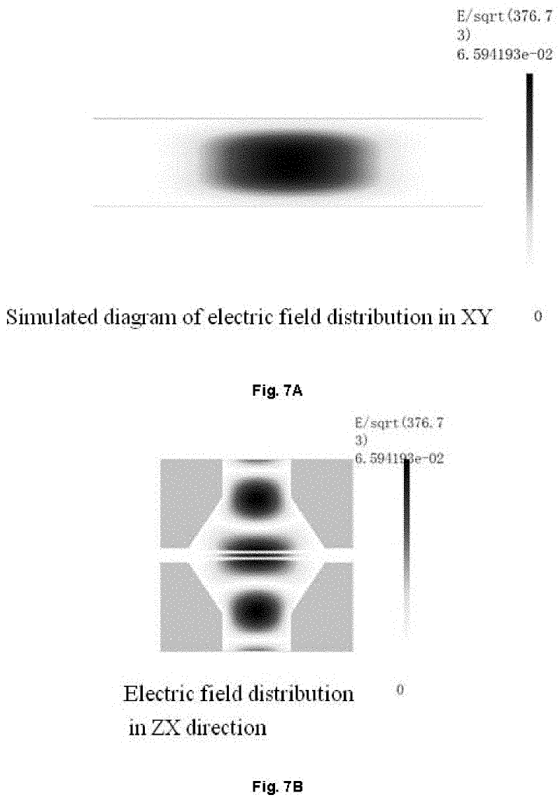

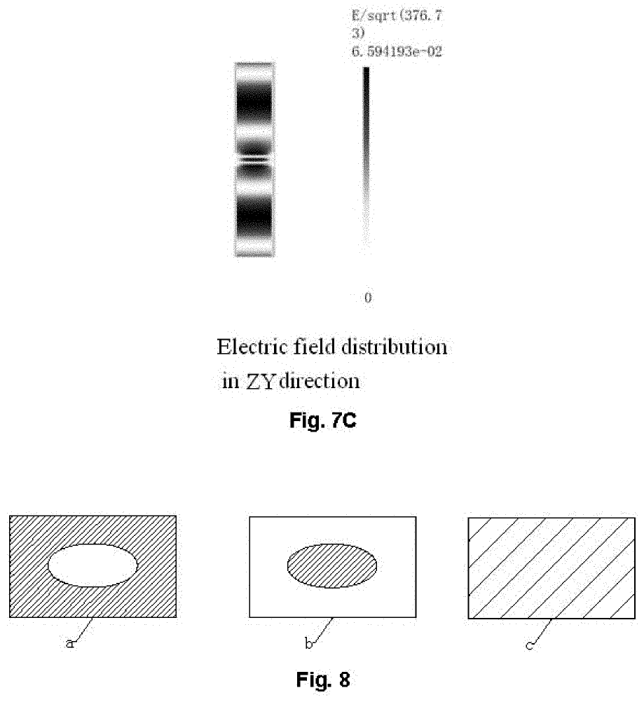

The metal detector 3 is provided on one side of a feeding end of a conveyor belt, and can detect metal-containing materials. After generating an alarm, manual screening is performed to screen out the metal-containing materials at a feeding inlet to avoid metal substances from entering the microwave processing system. If there is a small volume of metal, microwaves will enter from the surrounding of the metal. The temperature of the surrounding area of the metal is too high, the temperature difference is large, and the quality is degraded. The larger metal will cause microwave shielding and cannot implement defrosting. The microwave processing system is arranged behind the metal detector, and includes two or more microwave processing modules 4 connected in sequence, which may be optimally combined according to different requirements to obtain better heating uniformity. The modular design of microwave heating cavity is adopted, that is, there are multiple microwave heating cavities, different parameter settings can make the heating type of each heating cavity different, FIG. 7A-FIG. 7C is taken as an example, that is, in the actual electric field distribution, and when a material continuously passes through the first heating cavity and a second heating cavity, due to the different energy distribution, the heat type complementary effect can be achieved. FIG. 8 is taken as an example. If the energy of the heating cavity a is concentrated in the middle, that is, the middle is a hot point area, the energy of the heating cavity b is concentrated around, after passing through the two microwave heating cavities, the temperature difference between the cold and hot points will be reduced, and better uniformity can be achieved.

As shown in FIG. 2, two microwave processors 7 are provided at an interval. The 433 MHz solid state microwave heating cavity and industrial defrosting system includes a front-end channel cover 8, a middle connecting cover 9 and a rear-end channel cover 10. The front-end channel cover 8 is connected to an inlet end of right microwave processor 7 in FIG. 1 and extends forward for a distance. The rear-end channel cover 10 is connected to an outlet end of the left microwave processor 7 in FIG. 1 and extends backward for a distance. The middle connecting cover 9 is connected between the inlet end of the left microwave processor 7 and the outlet end of the right microwave processor 7, so that the front-end channel cover 8, the middle connecting cover 9, the rear-end channel cover 10 and the two heating cavities form a complete heating channel through which food passes, while preventing the heat of microwave radiation from escaping, improving energy efficiency and avoiding radiation.

As shown in FIG. 3, an upper part and a bottom part of the microwave processing module 4 are provided with a microwave source 41 separately, the microwave sources 41 are connected to bell mouths 43 through wave guide tubes 42, the bell mouths are configured to evenly disperse the microwave, it can be designed in advance according to the type and size of defrosted products, and the components can be replaced later as needed to ensure the uniformity of heating. The upper and lower bell mouths are connected to central heating cavity 45 through the microwave windows 44, respectively, the microwave enters the heating cavity through the microwave window, and the microwave window can also prevent water vapor and dust from entering the instrument. The microwave source is a 433 MHz solid-state microwave source. As shown in FIG. 6, a side surface of the heating cavity is provided with a reflecting surface adjusting device, including a metal inner plate 451, a screw rod 452 and a scissor adjusting mechanism 453, both ends of the scissor adjusting mechanism 453 are fixedly connected to the inner plate 451 and a metal plate 46 on the side surface of the heating cavity, respectively, the screw rod passes through the metal plate, and an end is a handle 454. The handle is rotated to adjust the length of the screw rod in the heating cavity, thereby adjusting the position of the inner plate and adjusting the width of the heating cavity, so as to adjust the electric field distribution according to the actual situation to ensure the uniformity of heating. The 433 MHz wavelength is very long, the screw rod and the hole are in screw thread contact and no gap, which can prevent the microwave from leaking out.

The sample conveying device 2 includes gears 21 provided on both sides of the machine frame, and a chain conveyor belt mounted on the gears, the chain conveyor belt is made of a non-metallic material, for example but not limited to, a plastic material, and a bottom part of the chain conveyor belt is provided with a support member made of a non-metallic material. Further, the support member has a T-shaped structure, which is used to support the chain conveyor belt to adjust the degree of tightness and/or relaxation of the chain conveyor belt, so as to keep the chain plate conveyor belt running stably.

A discharging end of the sample conveying device is provided with an infrared temperature measuring instrument 7, capable of measuring the surface temperature of a sample in real time, and monitoring a defrosting situation.

The machine frame is further provided with a control system 6, including a PLC and a touch screen connected to the PLC, and the PLC controls the sample conveying device 2, the metal detector 3, the microwave processing system 4, the infrared temperature measuring instrument 7, and the motor 5 through the cable. The touch screen is used to operate the computer, set the operation, alarm, prompt and other instructions, establish a defrosting material process package database, perform related processes according to different materials, and set a function of automatic defrosting with materials and automatic standby without materials.

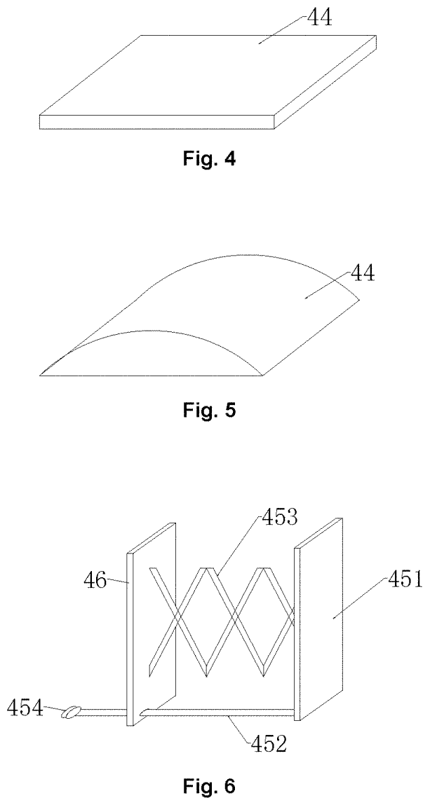

As shown in FIG. 4, the microwave window is a flat plate shape, and the flat plate shape is a commonly used microwave window, which is convenient to manufacture. The microwave window of the heating cavity may be designed in different shapes, for flat windows, hemispherical or lenticular (convex or concave lenses) converging or dispersing, to adjust the electric field distribution and the temperature distribution inside the material.

The front and rear ends of the microwave processing system are open for the sample conveying device to pass through, both the feeding end and the discharging end of the sample conveying device are provided with a microwave suppressor, the microwave suppressor includes a reflecting part and an absorbing part, the reflecting part is usually metal of an irregular shape, and the absorbing part is usually a graphene or silicon carbide plate, which is used to absorb the reflected microwave. The microwave suppressor currently on the market can be used. For the specific structure, reference may be made to patent 201310631185.1 “Microwave Suppressor and Tunnel Microwave Heating System” and 2018212792024 “Archipelago Microwave Suppressor”. The test results show that the microwave leakage during the microwave operation of the disclosure is generally 1-2.5 mW/cm².

In the present embodiment, the 433 MHz solid-state microwave source is electrically connected to the PLC, and a working state of the 433 MHz solid-state microwave source is adjusted through the touch screen. The 433 MHz solid-state microwave source is capable of calculating the intensity of a reflected wave and acquiring corresponding dielectric characteristic parameter information according to the intensity of the reflected wave. The 433 MHz solid-state microwave source acquires dielectric characteristic parameter information in real time, and determines a defrosting state of current food according to the change of the dielectric characteristic parameter information. The equipment can analyze changes in the dielectric properties of defrosted foods by calculating the intensity of reflected waves (reflected power). Due to the phase change before and after defrosting, the dielectric properties of food are changed significantly, and when the dielectric characteristic value reaches a certain range, the corresponding defrosting situation is determined.

Specifically, the touch screen is capable of displaying the following information: species of food, intensity of the reflected wave, reflected power, real-time dielectric characteristic parameter information, and the defrosting state.

In the present embodiment, the PLC adjusts the heating power of the 433 MHz solid-state microwave source corresponding to the next microwave processing module according to the defrosting state of the current food, so as to achieve heat type complementation of each microwave processing module. The control system may automatically adjust the power of the heating cavity to be passed, the adjusting power can be automatically matched for the material that is being defrosted, the defrosting time is shortened, the temperature difference between cold and hot points is reduced, and the defrosting temperature of the same batch is more uniform.

In an exemplary embodiment, there are two or more heating cavities, so as to realize the complementary heat type of each microwave processing module and achieve the purpose of defrosting different foods uniformly.

There are multiple reflecting surface adjusting devices, each of the heating cavities is provided with two reflecting surface adjusting devices, the two reflecting surface adjusting devices in the same heating cavity are respectively provided on both sides of the sample conveying device, the space between the two inner plates of the two reflecting surface adjusting devices is the space through which food passes, and a distance between the two inner plates is adjusted to adjust an electric field distribution. Equipment is suitable for multiple materials.

### Embodiment 2

As shown in FIG. 5, the microwave window is a solid cylindrical shape. The solid cylindrical type can better focus the microwave.

The height of the heating cavity is 30-60 cm and the width is 30-60 cm, which is suitable for the defrosting of various meat standard packages (30 cm*60 cm*20 cm) and different shapes and sizes of meat and seafood.

The rest are the same as in Embodiment 1.

### Embodiment 3

The microwave power of the microwave processing module is greater than or equal to 20 KW. The wave guide tube selects the national standard BJ4, and has a width of 533.4 mm and a height of 266.7 mm.

The rest are the same as in Embodiment 1.

### Embodiment 4

The reflecting surface adjusting device is different from that in Embodiment 1. Specifically, the reflecting surface adjusting device includes a metal inner plate, a servo motor and a scissor adjusting mechanism. Both ends of the scissor adjusting mechanism are fixedly connected to the inner plate and the metal plate on the side surface of the heating cavity to ensure no leakage during microwave conveying.

The device is applied to the defrosting of various meat standard packages (30 cm*60 cm*20 cm) and meat and seafood of different shapes and sizes. The material can be returned to the temperature range of −4° C. to −2° C. . Meat standard packages (30 cm*60 cm*20 cm, with plastic packaging films) are included: duck meat, beef quarters, beef tenths, pork sixths, lamb, etc.; irregular shapes and sizes of food: lamb legs, whole chickens, ducks, livestock, poultry, etc.; aquatic products: fish slip, shrimp slip, surimi, frozen shrimp, etc. According to different objects, different sizes of the bell mouth, the size and type of the microwave window and the width of the heating cavity can be designed. When changing the defrosted object, only the corresponding size parts need to be replaced according to the object. The entire production cable does not need large-scale reconstruction, which greatly improves the flexibility of use and saves a lot of costs.

The defrosting process is as follows: a material is placed on a food carrier, a meat standard block or a sample to be defrosted is placed on a feeding end of a conveyor belt, after a metal detector passes the test, the conveyor belt runs automatically, a target defrosting temperature is reached by microwave processing of a microwave heating cavity, after an infrared temperature measuring instrument measures the temperature, the material is discharged from a discharging end, and quick non-destructive defrosting is realized.

What is claimed is:

1. 433 MHz solid state microwave heating cavity and industrial defrosting system, comprising: a sample conveying device, a metal detector, a microwave processing system, and a motor, provided on a machine frame, wherein
the motor is connected to the sample conveying device through a cable;
the sample conveying device is a non-metallic conveying device, passes through the microwave processing system, and runs from the metal detector to a direction of the microwave processing system;
the metal detector is provided at a feeding end of the sample conveying device;
the microwave processing system is arranged behind the metal detector, the microwave processing system comprises two or more microwave processing modules connected in sequence, and each of the microwave processing modules has complementary heat types;
an upper part and a bottom part of each of the microwave processing modules are provided with a microwave source separately, microwave sources are connected to bell mouths of the microwave processing module through wave guide tubes, and an upper bell mouth of the bell mouths and a lower bell mouth of the bell mouths are connected to a heating cavity in a middle of the microwave processing module through microwave windows, respectively;
the microwave source is a 433 MHz solid-state microwave source; and
a side surface of the heating cavity is provided with a reflecting surface adjusting device, the reflecting surface adjusting device comprises a metal inner plate, a screw rod and a scissor adjusting mechanism, both ends of the scissor adjusting mechanism are fixedly connected to the inner plate and a metal plate on a side surface of the heating cavity, respectively, the screw rod passes through the metal plate, and an end of the screw rod is provided with a handle.

2. The 433 MHz solid state microwave heating cavity and industrial defrosting system as claimed in claim 1, wherein the sample conveying device comprises gears provided on both sides of the machine frame, and a chain conveyor belt mounted on the gears, the chain conveyor belt is made of a non-metallic material, a bottom part of the chain conveyor belt is provided with a support member made of a non-metallic material, the support member is configured to adjust a tightness and/or relaxation of the chain conveyor belt to keep the chain conveyor belt running stably.

3. The 433 MHz solid state microwave heating cavity and industrial defrosting system as claimed in claim 1, wherein a discharging end of the sample conveying device is provided with an infrared temperature measuring instrument.

4. The 433 MHz solid state microwave heating cavity and industrial defrosting system as claimed in claim 3, wherein the machine frame is further provided with a control system, the control system comprises a PLC and a touch screen connected to the PLC, and the PLC controls the sample conveying device, the metal detector, the microwave processing system, the infrared temperature measuring instrument, and the motor through the cable.

5. The 433 MHz solid state microwave heating cavity and industrial defrosting system as claimed in claim 1, wherein the microwave window is one of a flat plate shape, a solid cylindrical shape, a convex lens, and a concave lens to achieve microwave concentration or scattering.

6. The 433 MHz solid state microwave heating cavity and industrial defrosting system as claimed in claim 1, wherein
a height of the heating cavity is 30-60 cm; and
a width of the heating cavity is 30-60 cm.

7. The 433 MHz solid state microwave heating cavity and industrial defrosting system as claimed in claim 1, wherein both a feeding end and a discharging end of the sample conveying device are provided with a microwave suppressor.

8. The 433 MHz solid state microwave heating cavity and industrial defrosting system as claimed in claim 1, wherein a microwave power of the microwave processing module is greater than or equal to 20 KW.

9. The 433 MHz solid state microwave heating cavity and industrial defrosting system as claimed in claim 1, wherein
a width of each of the wave guide tubes is 533.4 mm; and
a height of each of the wave guide tubes is 266.7 mm.

10. The 433 MHz solid state microwave heating cavity and industrial defrosting system as claimed in claim 4, wherein
the 433 MHz solid-state microwave source is electrically connected to the PLC, and a working state of the 433 MHz solid-state microwave source is adjusted through the touch screen;
the 433 MHz solid-state microwave source is capable of calculating an intensity of a reflected wave and acquiring corresponding dielectric characteristic parameter information according to the intensity of the reflected wave; and
the 433 MHz solid-state microwave source acquires the dielectric characteristic parameter information in real time, and determines a defrosting state of current food according to a change of the dielectric characteristic parameter information.

11. The 433 MHz solid state microwave heating cavity and industrial defrosting system as claimed in claim 10, wherein
the touch screen is capable of displaying the following information: species of food, the intensity of the reflected wave, reflected power, real-time dielectric characteristic parameter information, and the defrosting state.

12. The 433 MHz solid state microwave heating cavity and industrial defrosting system as claimed in claim 10, wherein
the PLC adjusts the heating power of the 433 MHz solid-state microwave source corresponding to next microwave processing module according to the defrosting state of the current food, so as to achieve uniform defrosting of the food while saving energy.

13. The 433 MHz solid state microwave heating cavity and industrial defrosting system as claimed in claim 10, wherein there are two or more heating cavities, the PLC adjusts the heating power of the 433 MHz solid-state microwave source corresponding to next microwave processing module according to the defrosting state of the current food, so as to realize the complementary heat type of each microwave processing module and achieve a purpose of defrosting different foods uniformly.

14. The 433 MHz solid state microwave heating cavity and industrial defrosting system as claimed in claim 1, wherein
there are a plurality of reflecting surface adjusting devices, each of heating cavities is provided with two reflecting surface adjusting devices, the two reflecting surface adjusting devices in the same heating cavity are respectively provided on both sides of the sample conveying device, a space between two inner plates of the two reflecting surface adjusting devices is a space through which food passes, a distance between the two inner plates is adjusted to adjust an electric field distribution, and each of the inner plates is adjustable independently.
